(19) United States
(12) Patent Application Publication
(10) Pub. No.: US 2021/0225053 A1
(43) Pub. Date: Jul. 22, 2021

(54) INFORMATION PROCESSING APPARATUS, INFORMATION PROCESSING METHOD, AND PROGRAM

(71) Applicant: SONY CORPORATION, TOKYO (JP)

(72) Inventors: HIDENORI AOKI, TOKYO (JP); YASUKE ISHIHARA, TOKYO (JP); KEIJIROH NAGANO, TOKYO (JP); FUJIO ARAI, TOKYO (JP); SHINTARO TSUTSUI, TOKYO (JP)

(21) Appl. No.: 17/059,751

(22) PCT Filed: May 23, 2019
(86) PCT No.: PCT/JP2019/020379

§ 371 Date: Nov. 30, 2020

(30) Foreign Application Priority Data
Jun. 6, 2018 (JP) 2018-108329

(51) Int. Cl. G06T 11/60; G06K 9/00; G06T 7/13

(52) U.S. Cl. CPC G06T 11/60; G06K 9/00818; G06T 2207/30252; G06K 2209/01; G06T 7/13

(57) ABSTRACT

The present disclosure relates to an information processing apparatus, an information processing method, and a program adapted to preferentially display a virtual object desired to be presented to a user. On the basis of position information regarding a display apparatus for displaying content, an object acquisition section acquires object information regarding display objects included in the content. A rendering processing section performs a process of rendering a first display object in preference over a process of rendering a second display object, on the basis of the acquired object information. A display control section controls the display apparatus to display the display object of which the rendering process is completed, on the basis of the position information. The technology of the present disclosure may be applied, for example, to HMDs for AR use.

### TECHNICAL FIELD

The present disclosure relates to an information processing apparatus, an information processing method, and a program. More particularly, the disclosure relates to an information processing apparatus, an information processing method, and a program adapted to preferentially display a virtual object desired to be presented to a user.

### BACKGROUND ART

In recent years, there has been a technology known as AR (Augmented Reality). The AR technology allows the user to be presented with virtual objects in diverse modes such as texts, icons, and animations superposed one on top of the other (such objects are referred to as the virtual objects hereunder), as opposed to real objects in an image captured in real space.

With the AR technology, depending on the virtual objects to be presented, the load of the processes of rendering them becomes so heavy that a delay may occur in the period from the start of rendering the virtual objects to their display. In the case where the viewpoint position of the user is changed before the virtual objects are presented to the user, there occurs a relative shift between the user's viewpoint position on one hand and a position at which the virtual objects are superposed one on top of the other on the other hand.

Given the above discrepancy, PTL 1 discloses a technology for correcting the display positions of virtual objects rendered individually in multiple buffers, on the basis of the positional relations between real objects reflecting the result of recognizing these real objects in the real space on one hand and the viewpoint on the other hand.

### CITATION LIST

### Patent Literature

[PTL 1]

PCT Patent Publication No. WO2017/183346

### SUMMARY

### Technical Problem

However, the AR technology that involves having virtual objects superposed one on top of the other in the real space has given little consideration to preferentially rendering an important virtual object desired to be presented to the user.

The present disclosure has been made in view of the above circumstances and is aimed at preferentially rendering a virtual object desired to be presented to a user.

### Solution to Problem

According to the present disclosure, there is provided an information processing apparatus including an object acquisition section configured to, on the basis of position information regarding a display apparatus for displaying content, acquire object information regarding display objects included in the content; a rendering processing section configured to perform a process of rendering a first display object in preference over a process of rendering a second display object, on the basis of the acquired object information; and a display control section configured to control the display apparatus to display the display object of which the rendering process is completed, on the basis of the position information.

Also according to the present disclosure, there is provided an information processing method including, on the basis of position information regarding a display apparatus for displaying content, causing an information processing apparatus to acquire object information regarding display objects included in the content; causing the information processing apparatus to perform a process of rendering a first display object in preference over a process of rendering a second display object, on the basis of the acquired object information; and causing the information processing apparatus to control the display apparatus to display the display object of which the rendering process is completed, on the basis of the position information.

Also according to the present disclosure, there is provided a program for causing a computer to execute a process including, on the basis of position information regarding a display apparatus for displaying content, acquiring object information regarding display objects included in the content; performing a process of rendering a first display object in preference over a process of rendering a second display object, on the basis of the acquired object information; and controlling the display apparatus to display the display object of which the rendering process is completed, on the basis of the position information.

Thus, according to the present disclosure, on the basis of position information regarding a display apparatus for displaying content, object information regarding display objects included in the content is acquired. A process of rendering a first display object is performed in preference over a process of rendering a second display object, on the basis of the acquired object information. The display apparatus is controlled to display the display object of which the rendering process is completed, on the basis of the position information.

### Advantageous Effect of Invention

According to the present disclosure, it is possible to preferentially render a virtual object desired to be presented to a user.

The advantageous effect outlined above is not limitative of the present disclosure. Further advantages will become apparent from a reading of the present disclosure.

### BRIEF DESCRIPTION OF DRAWINGS

FIG. 1 is a view depicting an external configuration of an AR-HMD to which the technology of the present disclosure is applied.

FIG. 2 is a block diagram depicting a configuration example of the AR-HMD as an information processing apparatus.

FIG. 3 is a block diagram depicting a functional configuration example of the AR-HMD.

FIG. 4 is a flowchart explaining an object display process.

FIG. 5 is another flowchart explaining the object display process.

FIG. 6 is a view depicting an example of a display object list.

FIG. 7 is a view depicting examples of temporary objects.

FIG. 8 is a view explaining how temporary objects are displayed superposed.

FIG. 9 is a view explaining how a temporary object is replaced.

FIG. 10 is a view depicting an example of a temporary object that uses template objects.

FIG. 11 is a view depicting an example of display on a vehicle-mounted HUD.

FIG. 12 is a view depicting another example of the display object list.

FIG. 13 is a block diagram depicting a configuration example of a computer.

### DESCRIPTION OF EMBODIMENTS

Some preferred embodiments for implementing the present disclosure (referred to as the embodiment hereunder) are described below. The description will be given in the following order.
1. Overview of the technology of the present disclosure
2. Configuration of the AR-HMD
3. Operation of the AR-HMD
4. Alternative examples
5. Usage examples
6. Configuration example of the computer

### 1. OVERVIEW OF THE TECHNOLOGY OF THE PRESENT DISCLOSURE

The technology of the present disclosure is applied to display apparatuses such as an HMD (Head-Mounted Display) for AR use or the HMD for VR (Virtual Reality) use, for example. The HMD may take various forms, such as an eyeglass type, a cap type, a belt type surrounding and fastened to a user's head, or a hardhat type covering the user's entire head. The technology of the present disclosure may also be applied to a HUD (Head-Up Display).

For the AR technology that causes virtual objects to be displayed superposed in the real space (such objects are also referred to as the display objects hereunder), what is important is the immediacy of instantaneously displaying the display objects in keeping with the viewpoint of the user. However, the processes of rendering such display objects as 3D objects take time. On low-spec hardware in particular, there may occur delays in display.

Meanwhile, not all display objects to be displayed are equally important. For example, there are display objects of which the influence of delay in display, if any, is small from a scenario point of view, as in the case of a background being displayed in such content as games.

In view of the foregoing, the technology of the present disclosure is aimed at preferentially performing the process of rendering important display objects, thereby implementing the display of elements that are important from a scenario point of view. The priority levels for the rendering processes may be set by the system on the basis of predetermined rules or may be determined in advance.

Also according to the technology of the present disclosure, temporary objects which correspond to the display objects to be presented and which consume small amounts of information are created and displayed in place of the display objects to be displayed. This ensures the immediacy of display.

In particular, in the case where a display object with a low priority level in terms of rendering is to be displayed superposed on an important display object, a temporary object corresponding to the low-priority display object is created and superposed on the important object. In this manner, the important display object is preferentially displayed.

### 2. CONFIGURATION OF THE AR-HMD

(External Configuration)

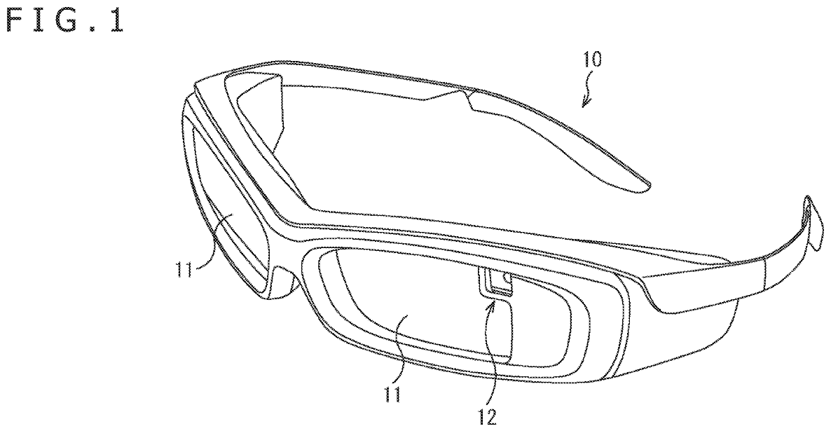

FIG. 1 is a view depicting an external configuration of an HMD for AR use (referred to as the AR-HMD hereunder) to which the technology of the present disclosure is applied.

An AR-HMD 10 in FIG. 1 is configured as AR glasses that take the shape of eyeglasses as a whole. The AR-HMD 10 includes a display section 11 and a camera 12.

The display section 11 corresponds to the lenses of eyeglasses. For example, the entire display section 11 is configured as a transmissive display. Display objects (virtual objects) are transmissively displayed superposed on real-world objects (real objects) viewed directly by the user. That is, the AR-HMD 10 is configured as transmissive AR glasses.

The camera 12 is attached to an edge of the display section 11 corresponding to the left eye of the user wearing the AR-HMD 10. The camera 12 captures images of the real space included in the field of view of the user. For example, the camera 12 is configured using a solid-state image sensor such as a CCD (Charge Coupled Device) image sensor or a CMOS (Complementary Metal Oxide Semiconductor) image sensor. Note that there may be provided multiple units of each of these sensors. That is, the camera 12 may be configured as a stereo camera.

The display section 11 is caused to display images captured by the camera 12. The display section 11 may also be caused to superpose and display objects on the captured images.

Further, although not depicted, a housing of the AR-HMD 10 that corresponds to the frame of eyeglasses is connected in a wired or wireless fashion with a controller that houses or carries various sensors, buttons, and speakers.

(Configuration Example of the AR-HMD as an Information Processing Apparatus)

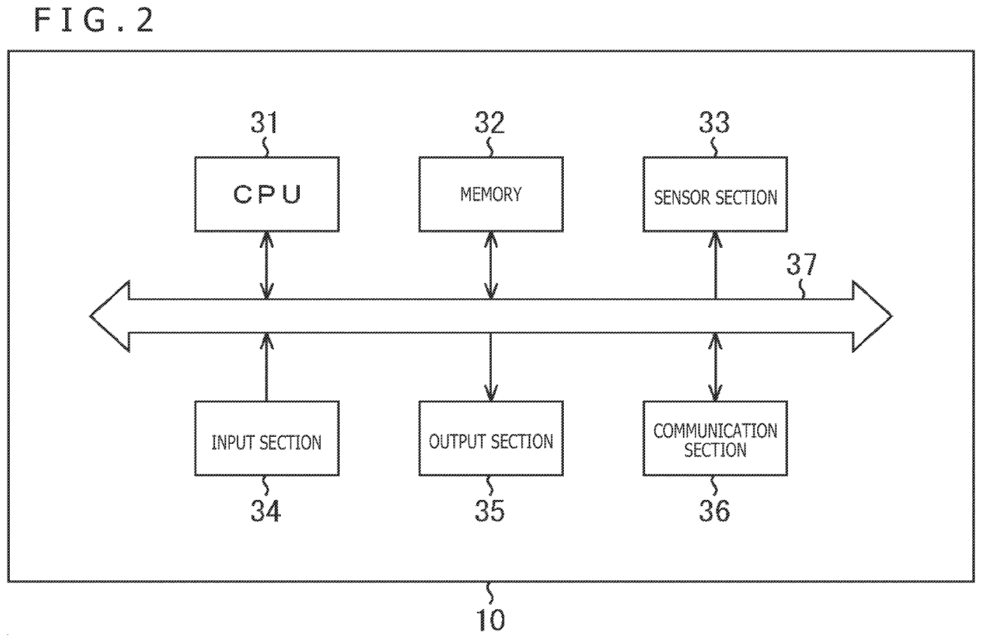

FIG. 2 is a block diagram depicting a configuration example of the AR-HMD 10 as an information processing apparatus.

The AR-HMD 10 in FIG. 2 includes a CPU (Central Processor Unit) 31, a memory 32, a sensor section 33, an input section 34, an output section 35, and a communication section 36. These components are interconnected via a bus 37.

The CPU 31 performs processes to implement diverse functions provided by the AR-HMD 10, according to programs and data stored in the memory 32. For example, the CPU 31 includes multiple cores.

The memory 32 is a storage section including a storage medium such as a semiconductor memory or a hard disk. The memory 32 stores the programs and data for use by the CPU 31 during processing.

The sensor section 33 includes various sensors such as a microphone, a gyro sensor, a line-of-sight sensor, and an acceleration sensor, in addition to the camera 12 in FIG. 1. Various sensing results acquired by the sensor section 33 are also used by the CPU 31 during processing.

The input section 34 includes buttons, keys, and a touch panel. The output section 35 includes the display section 11 in FIG. 1 and speakers. The communication section 36 is configured as a communication interface that mediates various kinds of wired or wireless communication.

(Functional Configuration Example of the AR-HMD)

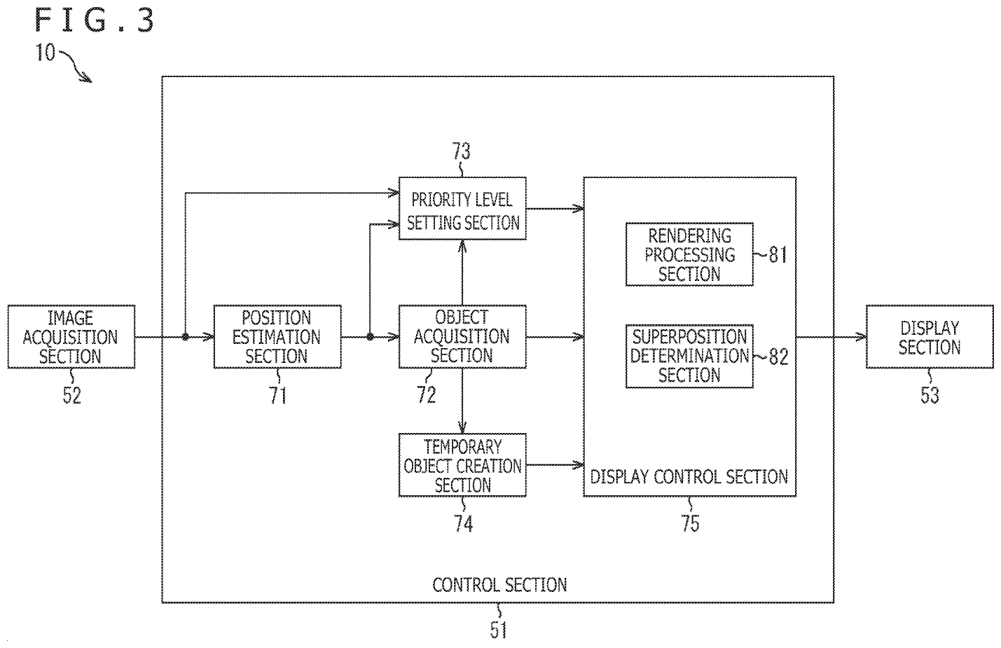

FIG. 3 is a block diagram depicting a functional configuration example of the AR-HMD 10 to which the technology of the present disclosure is applied.

The AR-HMD 10 in FIG. 3 includes a control section 51, an image acquisition section 52, and a display section 53.

The control section 51 corresponds to the CPU 31 in FIG. 2. The control section 51 performs processes to implement the diverse functions provided by the AR-HMD 10.

The image acquisition section 52 corresponds to the camera 12 in FIG. 1. The image acquisition section 52 acquires images captured in the real space. The acquired images are supplied to the control section 51.

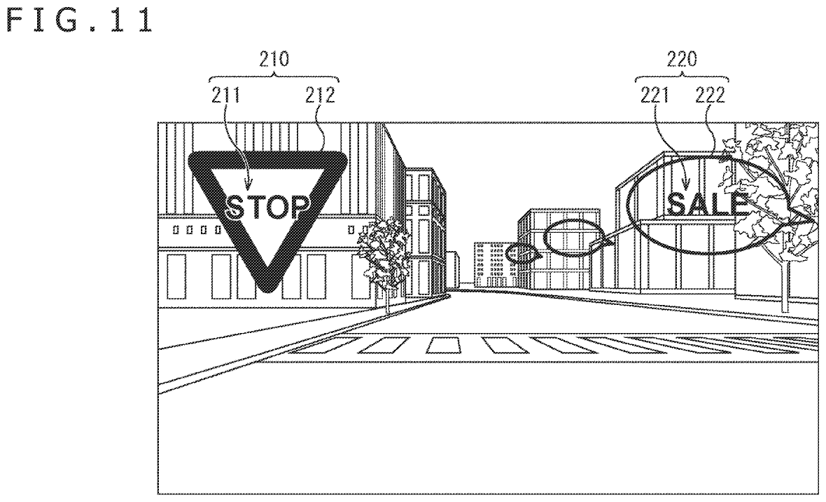

The display section 53 corresponds to the display section 11 in FIG. 11. Under control of the control section 51, the display section 53 causes display objects to be displayed superposed in the real space that is being viewed by the user.

The control section 51 implements a position estimation section 71, an object acquisition section 72, a priority setting section 73, a temporary object creation section 74, and a display control section 75 by executing predetermined programs.

The position estimation section 71 estimates the current position and posture (orientation) of the AR-HMD 10 in the real space from images supplied from the image acquisition section 52. Position information representing the estimation results (current position and posture of the AR-HMD 10) is supplied to the object acquisition section 72 and to the priority setting section 73. Note that the position information may be estimated on the basis of the sensing results from the gyro sensor (sensor section 33).

On the basis of the position information from the position estimation section 71, the object acquisition section 72 acquires object information regarding the display objects which constitute the content displayed on the display section 53 and which are to be displayed in a display area of the display section 53. The content in this context refers to AR content including all display objects that may be displayed on the display section 53, such as games.

The object information includes data that constitutes the source of the display objects, the data being used for performing the processes of rendering the display objects. The object information is stored in the memory 32 (FIG. 2), in an external storage device, or in a cloud. The object acquisition section 72 acquires the object information directly from the memory 32, from the external storage device, or from the cloud via the communication section 36.

The object information thus acquired is supplied to the display control section 75 together with the position information from the position estimation section 71. In addition, the object information is also supplied to the priority level setting section 73 and to the temporary object creation section 74.

The priority level setting section 73 sets the priority levels for the processes of rendering the display objects to be displayed in the display area of the display section 53, based on the image acquired by the image acquisition section 52 and on the position information from the position estimation section 71 in addition to the object information from the object acquisition section 72.

The priority levels are set in such a manner that the closer the display object is to the foreground, the higher the priority is set for that display object by use of depth (perspective) information concerning each of the display objects and included in the object information, for example.

Alternatively, the priority levels may be set in such a manner that the closer the display object is to the position at the end of the user's line of sight, the higher the priority is set for that display object, on the basis of line-of-sight information obtained as a result of sensing by the line-of-sight sensor and representing the user's line of sight.

As another alternative, the priority levels may be set in such a manner that the closer the display object is to the center position of the display area of the display section 53 the higher the priority is set for that display object, based on the image acquired by the image acquisition section 52 and on the position information from the position estimation section 71.

As a further alternative, the priority levels may be set depending on whether each display object is a dynamic object moving spontaneously in the content or a static object not moving spontaneously therein. In this case, the dynamic object, which attracts a high degree of attention from the user, is given higher priority than the static object.

As yet another alternative, the object information acquired by the object acquisition section 72 may include priority determined in advance by content creators. The priority levels may then be set on the basis of the object information.

Priority information representing the set priority levels is supplied to the display control section 75.

On the basis of the object information from the object acquisition section 72, the temporary object creation section 74 creates temporary objects individually corresponding to the display objects to be displayed in the display area of the display section 53.

The temporary objects are only of a shape in a specific color each created on the basis of edge information (contours) regarding the display objects. The processes of rendering the temporary objects exclude color rendering and ray tracing. Thus, the temporary objects may be said to be objects having smaller amounts of information than the display objects to be displayed, i.e., specifically, objects with smaller amounts of throughput required for the display (rendering processes).

The object information constituting the source of the created temporary objects is supplied to the display control section 75.

The display control section 75 controls the display of content on the display section 53. Specifically, on the basis of the object information and position information from the object acquisition section 72, the display control section 75 controls the display section 53 (AR-HMD 10) in such a manner that the display objects of which the rendering processes have been completed are arranged to be displayed at suitable positions in the display area of the display section 53 corresponding to the real space.

The display control section 75 includes a rendering processing section 81, a superposition determination section 82, and an integration section 83.

The rendering processing section 81 performs the processes of rendering the display objects on the basis of the object information. At this time, the rendering processing section 81 performs the processes of rendering the display objects in descending order of priority, according to the priority levels represented by the priority information from the priority level setting section 73. As a result of this, under control of the display control section 75, the display objects are displayed in the order in which their rendering processes are completed.

On the basis of the position information, the superposition determination section 82 determines whether or not a display object of which the rendering process is not completed (unprocessed display object) is to be displayed superposed on a display object whose rendering process is completed (processed display object).

With this embodiment, in the case where the unprocessed display object of which the rendering process is not completed is to be displayed superposed on the processed display object whose rendering process is completed, a temporary object corresponding to the unprocessed display object is displayed at a position where the unprocessed display object ought to be displayed superposed on the processed display object.

That is, the superposition determination section 82 determines whether or not there is a temporary object to be superposed on the processed display object of which the rendering process is completed.

In the case where there exists a temporary object to be superposed on the processed display object, the rendering processing section 81 performs the process of rendering that temporary object. The display control section 75 controls the display section 53 to display the temporary object in a manner superposed on the processed display object.

As described above, in the case where display objects are displayed partially superposed one on top of the other and where the display object in the background has higher priority than the one in the foreground, a temporary object is displayed in place of the display object in the foreground. This allows the user to recognize a state in which at least some object is superposed on the important display object in the background (i.e., a state in which the important display object is hidden behind some object).

On the other hand, in the case where there is no temporary object to be superposed on the processed display object, the display control section 75 controls the display section 53 to display the processed display object as it is.

Also, every time the process of rendering a display object according to the priority level is completed, the display control section 75 controls the display section 53 to display the processed display object in a manner integrated with the previously displayed processed display objects.

Incidentally, the control section 51 may be implemented alternatively by an external device connected with the AR-HMD 10 or by a server in a cloud.

### 3. OPERATION OF THE AR-HMD

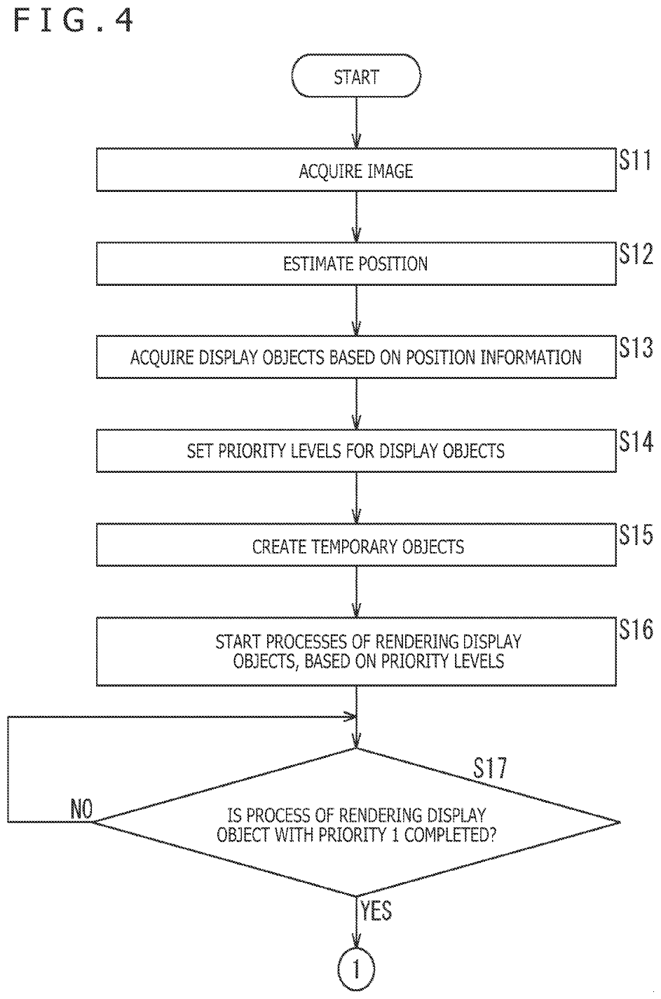

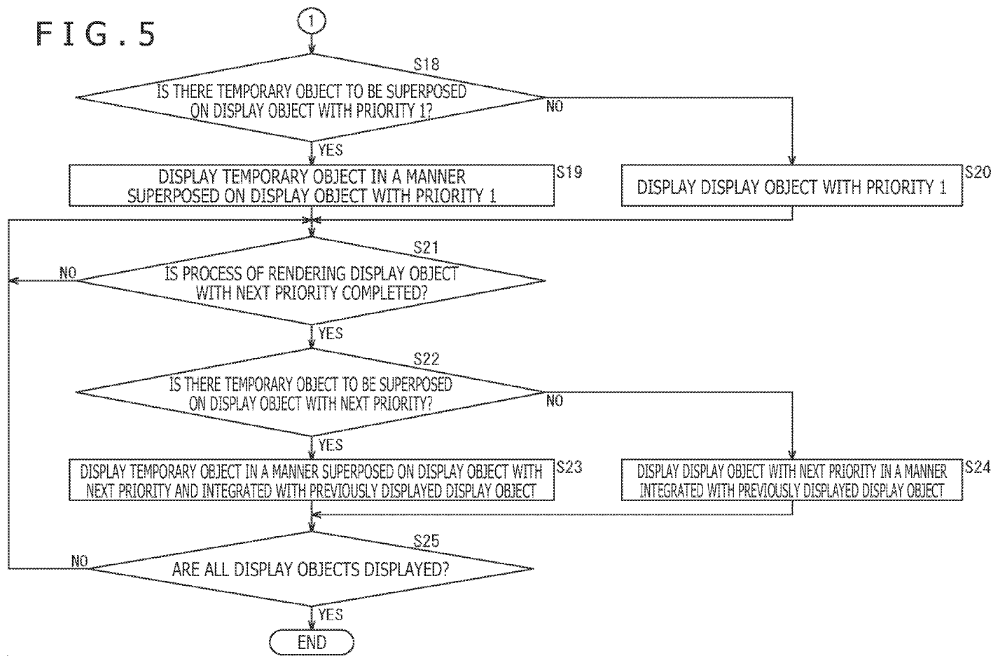

Explained below with reference to the flowcharts of FIGS. 4 and 5 is the process of displaying objects performed by the above-described AR-HMD 10.

In step S11, the image acquisition section 52 acquires an image captured in the real space.

In step S12, the position estimation section 71 estimates the current position and posture of the AR-HMD 10 from the image acquired by the image acquisition section 52. The position estimation section 71 supplies the position information indicative of the estimation results to the object acquisition section 72 and to the priority level setting section 73.

In step S13, on the basis of the position information from the position estimation section 71, the object acquisition section 72 acquires object information regarding the display objects to be displayed in the display area of the display section 53. For example, the object acquisition section 72 acquires a display object list as the object information.

Note that, in the case where there is no display object to be displayed in the display area of the display section 53, the subsequent steps are not carried out.

In step S14, on the basis of the object information from the object acquisition section 72, the priority level setting section 73 sets the priority levels for the processes of rendering the display objects to be displayed in the display area of the display section 53.

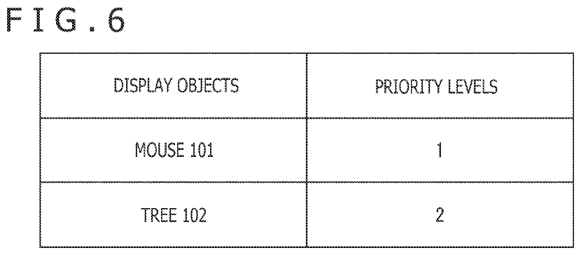

FIG. 6 depicts an example of the display object list acquired as the object information.

The display object list in FIG. 6 lists a mouse 101 and a tree 102 as the display objects to be displayed in the display area of the display section 53.

Here, the mouse 101 is a dynamic object that moves spontaneously, and the tree 102 is a static object not moving spontaneously. Thus, the mouse 101 is set with priority 1 as the priority level and the tree 102 with priority 2 as the priority level.

Preferably, the display object list in FIG. 6 may include the priority determined beforehand by content creators.

In step S15 back in the flowchart of FIG. 4, on the basis of the object information from the object acquisition section 72, the temporary object creation section 74 creates temporary objects corresponding individually to the display objects to be displayed in the display area of the display section 53.

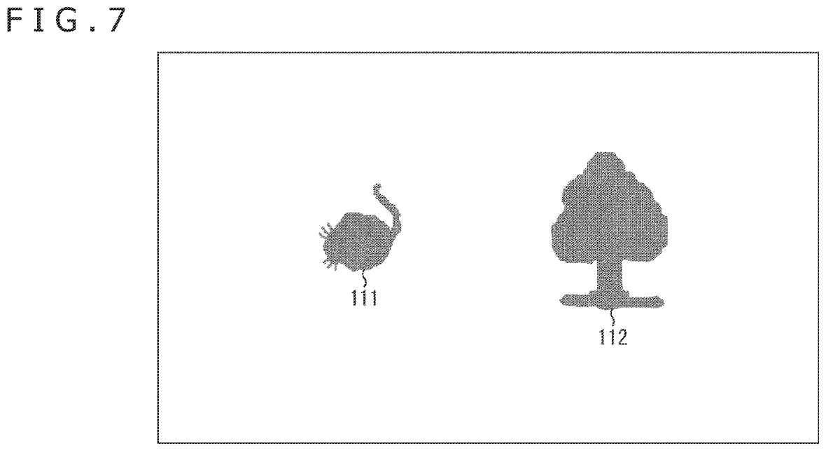

FIG. 7 depicts examples of temporary objects corresponding to the above-mentioned mouse 101 and tree 102.

A temporary object 111 and a temporary object 112 correspond to the mouse 101 and the tree 102, respectively. The temporary objects 111 and 112 are only of a shape filled with a specific color each.

Note that, at this stage, the temporary objects are not displayed on the display section 53.

In step S16, the rendering processing section 81 starts the processes of rendering the display objects on the basis of the priority levels set by the priority level setting section 73.

In step S17, the rendering processing section 81 determines whether or not the process of rendering the display object with priority 1 is completed. The processing of step S17 is repeated until the process of rendering the display object with priority 1 is completed.

After the process of rendering the display object with priority 1 is competed, control is transferred to step S18 in FIG. 5. In step S18, the superposition determination section 82 determines whether or not there is a temporary object to be superposed on the display object with priority 1.

In the case where it is determined in step S18 that there exists a temporary object to be superposed on the display object with priority 1, control is transferred to step S19.

In step S19, the rendering processing section 81 performs the process of rendering the temporary object. The display control section 75 controls the display section 53 to display the temporary object in a manner superposed on the display object with priority 1.

On the other hand, in the case where it is determined in step S18 that there is no temporary object to be superposed on the display object with priority 1, control is transferred to step S20. In step S20, the display control section 75 controls the display section 53 to display only the display object with priority 1.

In step S21 following step S19 or step S20, the rendering processing section 81 determines whether or not the process of rendering the display object with the next priority (e.g., priority 2) is completed. The processing of step S21 is also repeated until the process of rendering the display object with the next priority is completed.

After the process of rendering the display object with the next priority is completed, control is transferred to step S22. In step S22, the superposition determination section 82 determines whether or not there is a temporary object to be superposed on the display object with the next priority.

In the case where it is determined in step S22 that there exists a temporary object to be superposed on the display object with the next priority, control is transferred to step S23.

In step S23, the rendering processing section 81 performs the process of rendering the temporary object. The display control section 75 controls the display section 53 to display the temporary object in a manner superposed on the display object with the next priority and integrated with the display object with the preceding priority (i.e., previously displayed display object).

On the other hand, in the case where it is determined in step S23 that there is no temporary object to be superposed on the display object with the next priority, control is transferred to step S24.

In step S24, the display control section 75 controls the display section 53 to display the display object with the next priority in a manner integrated with the display object with the preceding priority (previously displayed display object).

Note that, in the case where the temporary object corresponding to the display object of which the rendering process has been completed is already displayed, that temporary object is deleted in step S23 or in step S24. In place of the deleted temporary object, the display object whose rendering process has been completed is displayed.

In step S25 following step S23 or step S24, the display control section 75 determines whether or not all display objects to be displayed in the display area of the display section 53 are displayed.

In the case where it is determined that not all display objects are displayed, control is returned to step S21. Steps S21 through S24 are then repeated until all display objects are displayed.

On the other hand, in the case where it is determined that all display objects have been displayed, the process is terminated.

For example, since the above-mentioned mouse 101 is higher in priority than the tree 102, the process of rendering the mouse 101 is completed earlier than the process of rendering the tree 102.

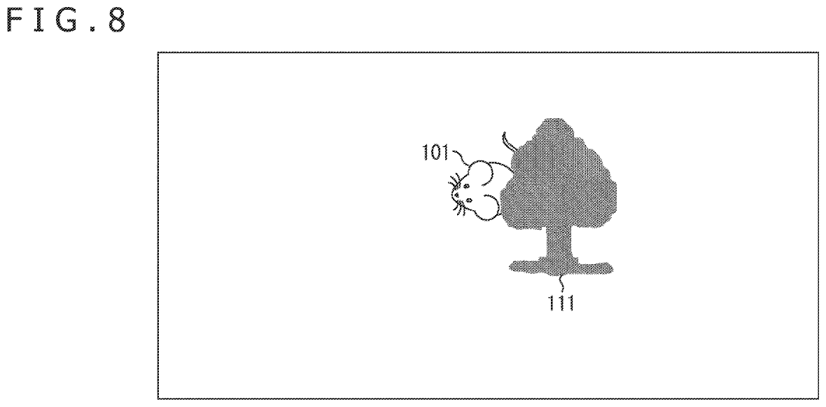

Here, in the case where the tree 102 is to be displayed partially superposed on the mouse 101 and where the mouse 101 is displayed after its rendering process is completed, the temporary object 112 corresponding to the tree 102 is displayed partially superposed on the mouse 101, as depicted in FIG. 8.

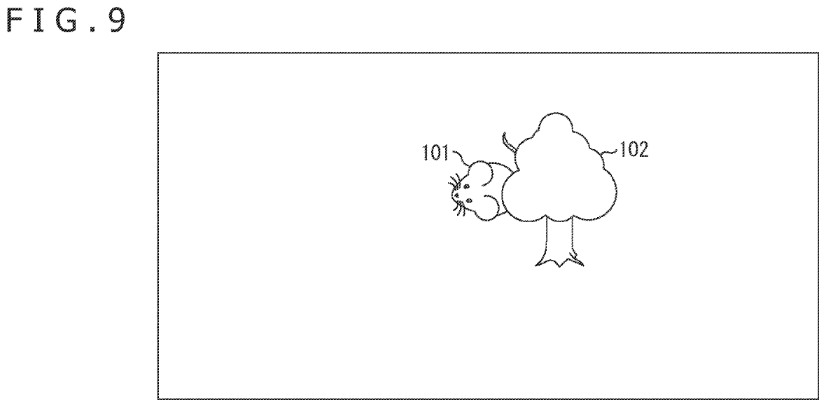

Thereafter, when the process of rendering the tree 102 is completed, the tree 102 is displayed replacing the temporary object 112, as illustrated in FIG. 9.

In the above-described steps, the processes of rendering the display objects are performed in descending order of priority based on the set priority levels. This makes it possible to preferentially display the display object desired to be presented to the user before the processes of rendering the other display objects are completed.

Further, in the case where a display object with lower priority is to be displayed partially superposed on the important display object, a temporary object is displayed in place of the display object having the lower priority. This allows the user to recognize the state in which the important display object is being hidden behind at least some other object.

Furthermore, in the case where the priority levels for the display objects are set on the basis of the priority determined beforehand by content creators, the display objects can be displayed in a manner intended by the content creators.

### 4. ALTERNATIVE EXAMPLES

Explained below are some alternative examples of the above-described embodiment.

### Alternative Example 1

It has been explained above that although temporary objects corresponding to all display objects to be displayed in the display area of the display section 53 are created, only the temporary object corresponding to the display object to be displayed superposed on a display object having higher priority is displayed.

Alternatively, at the time the temporary objects corresponding to all display objects to be displayed in the display area of the display section 53 are created, all temporary objects may be displayed before the process of rendering any of the display objects is completed. In this case, the display objects are displayed to replace the corresponding temporary objects in the order in which the processes of rendering the display objects are completed (i.e., in descending order of priority).

Because all display objects to be displayed in the display area of the display section 53 are displayed for the moment as temporary objects having smaller amounts of information, the display is implemented at high speed. It is thus possible to drastically shorten the period of time in which nothing is displayed in the display area.

### Alternative Example 2

It has been explained above that the temporary objects are created on the basis of the edge information regarding the display objects.

Alternatively, the temporary objects may each be created by use of multiple template objects having shapes determined beforehand.

The template objects each have a polygon such as a circle, a triangle, or a rectangle, or some other shape. The temporary objects may each be created by use of a single template object similar in shape to the corresponding display object, or by a combination of template objects such as circles or polygons.

The template objects are stored beforehand in a storage section such as the memory 32. The template objects are retrieved by the temporary object creation section 74 at the time of creating a temporary object.

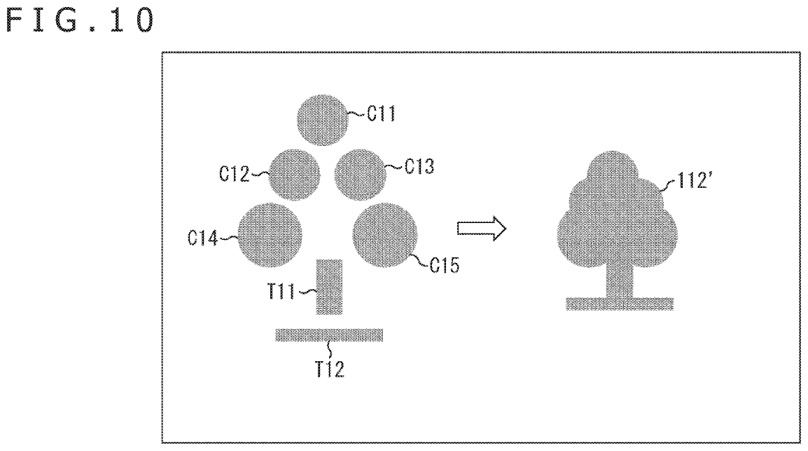

FIG. 10 depicts an example of a temporary object that uses multiple template objects.

The left part of FIG. 10 depicts circular template objects C11 to C15 as well as rectangular template objects T11 and T12.

The template objects C11 to C13 have a circular shape with the same size each. The template objects C14 and C15 each have a circular shape with the same size and are larger than the template objects C11 to C13.

The template object T11 has a vertically elongated rectangular shape. The template object T12 has a horizontally elongated rectangular shape.

In the example of FIG. 10, the template objects C11 to C15 and the template objects T11 and T12 are combined to create a temporary object 112′ corresponding to the tree 102, as illustrated in the right part of FIG. 10.

In such a manner, the temporary objects are created from template objects prepared in advance. This makes it possible to increase the processing speed of creating the temporary objects, thereby enabling even low-spec hardware to display content without delay under high processing load.

### Alternative Example 3

The portion of a display object on which a temporary object is superposed is hidden behind the temporary object. In that case, the process of rendering the display object may be terminated on that portion of the display object to be hidden behind the temporary object, with the display object displayed integrated with the temporary object.

In such a manner, the processing on the display portion not viewed by the user may be stopped to realize display at higher speed.

### Alternative Example 4

It has been explained above that a priority level is set for each of the display objects. Alternatively, a priority level may be set for each of the layers in which display objects are arranged.

In this case, the processes of rendering the display objects are performed on each of the layers in descending order of priority, the display objects in each layer being displayed in that order.

This makes it possible to display the important display objects collectively in units of scenes in the content.

### Alternative Example 5

In the case where a priority level is set for each of the layers as described above, the processes on each layer may be assigned to multiple cores incorporated in the CPU 31 and executed in parallel.

For example, in the case where 8 cores in the CPU 31 are to be used for the processes, 5 cores are assigned to the processes on the layer with a “high” priority level, 2 cores are assigned to the processes on the layer with an “intermediate” priority level, and 1 core is assigned to the processes on the layer with a “low” priority level.

In such a manner, the individual processes may be carried out in parallel using different processing capacities according to priority levels. In this case, however, the processes on the layer with an “intermediate” or “low” priority level may be terminated earlier than the processes on the layer with a “high” priority level if there are few display objects to be processed or if the amount of throughput is small in the layer having the “intermediate” or “low” priority level.

### 5. USAGE EXAMPLES

Explained below are some specific examples in which the technology of the present disclosure is put to use.

### (Example 1) Entertainment

The technology of the present disclosure may be applied to the content in the field of entertainment such as games that use the AR technology.

In an AR game, there may be scenes of which the impact is lost from a scenario point of view in the event of a delay in display. In that case, the priority levels are set for the processes of rendering the display objects in keeping with the scenes of the content (AR game). This makes it possible to prevent delays in display during the scenes that are important from a scenario point of view.

In addition, in recent years, there have been applications that provide 3D games on mobile terminals. Different mobile terminals have different specifications, with some of the terminals so pronounced in delay of display that they are incapable of letting the games played normally. Still, even in such cases, the processes of rendering important 3D objects may be performed preferentially to reduce the frequency with which game play is disrupted by delays in display.

### (Example 2) Vehicle-Mounted HUD

Recent years have seen the spread of a technology for providing information in the real space on an AR-HUD mounted on the vehicle (vehicle-mounted HUD). The technology of the present disclosure may also be applied to such vehicle-mounted HUDs.

In the case where the vehicle is traveling at high speed, it is preferred that the vehicle-mounted HUD not cause delays in display of the information regarding the traffic rules and route guidance.

For example, in the case where multiple display objects including information regarding the traffic rules are to be displayed, the processes of rendering display objects including larger amounts of character information are performed preferentially over the processes involving less character information.

Specifically, given a character object including character information denoting characters regarding the traffic rules and a graphic object including graphic information representing a graphic related to the traffic rules, the process of rendering the character object is performed preferentially over the process of rendering the graphic object. This enables the driver to obtain a necessary minimum of information.

FIG. 11 depicts an example of display on the vehicle-mounted HUD.

The vehicle-mounted HUD displays, in keeping with its position information, content that includes display objects regarding the traffic rules. In the example of FIG. 11, a display object 210 is displayed in the top left part in the display area of the vehicle-mounted HUD. A display object 220 is displayed in the top right part of the display area.

Note that, although not depicted in the drawing, the display area of the vehicle-mounted HUD also displays information related to speed, distance traveled, and navigation.

The display object 210 includes information regarding the traffic rules. The object information regarding the display object 210 is acquired on the basis of the position information. The display object 210 includes a character object 211 indicative of characters “STOP” and a graphic object 212 representing an inverted-triangle road sign.

On the other hand, the display object 220 does not include information regarding the traffic rules but includes discretionary annotation information that may optionally be given in the space by the user. The object information regarding the display object 220 is also acquired on the basis of the position information. The display object 220 includes a character object 221 denoting characters “SALE” indicating that shops are offering special sales and a balloon-shaped graphic object 222.

The vehicle-mounted HUD in FIG. 11 is arranged to perform the process of rendering the display object 210 that includes information regarding the traffic rules in preference over the display object 220 that does not include information regarding the traffic rules.

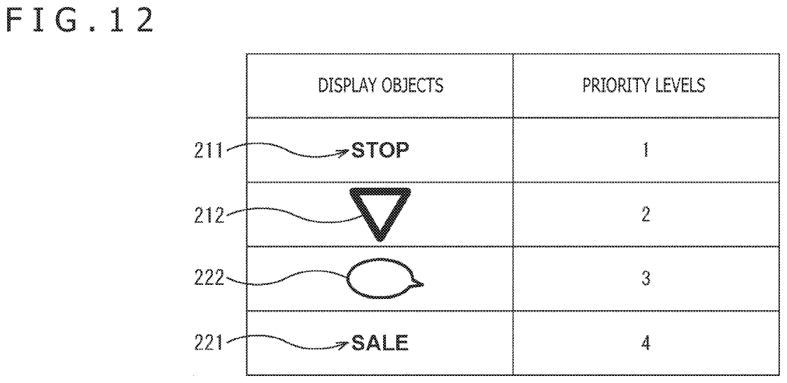

FIG. 12 depicts a typical list of the display objects found in FIG. 11.

The character object 211 includes character information indicative of characters regarding the traffic rules, and the graphic object 212 includes graphic information representing a graphic related to the traffic rules. As discussed above, the process of rendering the character object is performed in preference over the process of rendering the graphic object regarding the traffic rules. Thus, the character object 211 is set with priority 1 as the priority level and the graphic object 212 with priority 2 as the priority level.

Meanwhile, with respect to the display object indicative of the discretionary annotation information, the character object is set with a priority level lower than the graphic object indicating the presence of the annotation information, in order to avoid distracting the attention of the user during driving. Thus, the graphic object 222 is set with priority 3 as the priority level and the character object 221 with priority 4 as the priority level.

Note that, in the case where multiple display objects 220 are displayed, the objects including the characters “SALE” indicating that shops are offering special sales, the closer the shop is to the own vehicle, the higher the priority level with which the display object corresponding to the shop is set.

Also, in the example of FIG. 11, where the process of rendering any of the character object 211, the graphic object 212, the character object 221, and the graphic object 222 is not completed, a corresponding temporary object is displayed in its place as needed.

Note that, preferably, any corresponding temporary object may not be displayed in place of the character object 221 and graphic object 222 indicative of the discretionary annotation information. This makes it possible to prevent the display of temporary objects irrelevant to the traffic rules from distracting the attention of the user during driving.

Described above are examples in which the technology of the present disclosure is applied to the display apparatus for AR use. Alternatively, the technology of the present disclosure may be applied to display apparatuses for VR use. Specifically, the process of rendering a first display object to be displayed in a virtual space may be carried out in preference over the process of rendering a second display object.

### 6. CONFIGURATION EXAMPLE OF THE COMPUTER

The series of processes described above may be executed either by hardware or by software. Where the series of the processes is to be carried out by software, the programs constituting the software are installed into a suitable computer. Variations of the computer here include one with the software installed beforehand in its dedicated hardware and a general-purpose personal computer or like equipment capable of executing diverse functions based on the programs installed therein, for example.

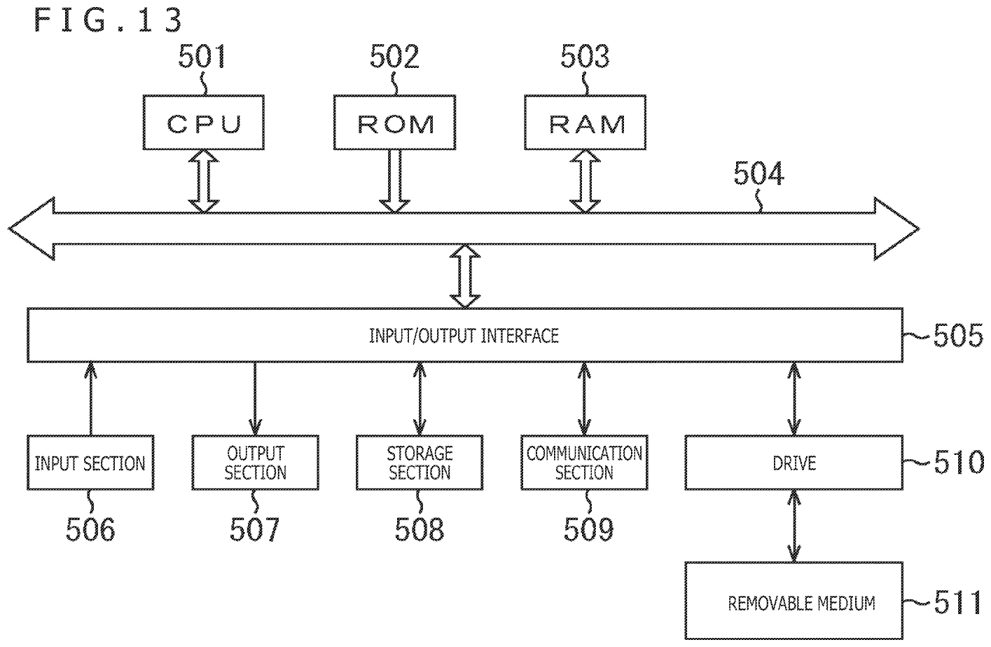

FIG. 13 is a block diagram depicting a hardware configuration example of a computer that executes the above-described series of the processes by using programs.

In the computer, a CPU 501, a ROM (Read Only Memory) 502, and a RAM (Random Access Memory) 503 are interconnected via a bus 504.

The bus 504 is further connected with an input/output interface 505. The input/output interface 505 is connected with an input section 506, an output section 507, a storage section 508, a communication section 509, and a drive 510.

The input section 506 includes a keyboard, a mouse, and a microphone. The output section 507 includes a display unit and speakers. The storage section 508 includes a hard disk and a nonvolatile memory. The communication section 509 includes a network interface. The drive 510 drives a removable medium 511 such as a magnetic disk, an optical disk, a magneto-optical disk, or a semiconductor memory.

In the computer configured as described above, the CPU 501 performs the above-described series of the processes by loading relevant programs from the storage section 508 where they are stored into the RAM 503 via the input/output interface 505 and bus 504 and by executing the loaded programs.

The programs to be executed by the computer (CPU 501) may be provided by being recorded on the removable medium 511 constituting a packaged medium, for example. The programs may alternatively be provided through a wired or wireless communication medium such as local area networks, the Internet, or digital satellite broadcasts.

On the computer, the removable medium 511 carrying the relevant programs may be attached to the drive 510, the programs getting installed from the attached medium into the storage section 508 via the input/output interface 505. Alternatively, the programs may be received by the communication section 509 through a wired or wireless transmission medium before being installed into the storage section 508. As another alternative, the programs may be preinstalled in the ROM 502 or in the storage section 508.

Incidentally, the programs to be executed by the computer may each be processed chronologically, i.e., in the sequence depicted in the present description, in parallel with other programs, or in otherwise appropriately timed fashion such as when the program is invoked as needed.

Also, the technology of the present disclosure is not limited to the preferred embodiments discussed above and may be implemented in diverse variations so far as they are within the scope of the technology of the present disclosure.

In addition, the advantageous effects stated in the present description are only examples and not limitative of the present technology that may also provide other advantages.

Further, the technology of the present disclosure may be implemented preferably in the following configurations.

(1)

An information processing apparatus including:

an object acquisition section configured to, on the basis of position information regarding a display apparatus for displaying content, acquire object information regarding display objects included in the content;

a rendering processing section configured to perform a process of rendering a first display object in preference over a process of rendering a second display object, on the basis of the acquired object information; and

a display control section configured to control the display apparatus to display the display object of which the rendering process is completed, on the basis of the position information.

(2)

The information processing apparatus as stated in paragraph (1) above, in which the display control section controls the display apparatus to display the first display object when the process of rendering the first display object is completed, as well as a temporary object having an amount of information smaller than that of the display object to be displayed, the temporary object corresponding to the second display object.

(3)

The information processing apparatus as stated in paragraph (2) above, in which the display control section controls the display apparatus to arrange and display the temporary object corresponding to the second display object at a position where the second display object ought to be displayed.

(4)

The information processing apparatus as stated in paragraph (3) above in which, on the basis of the position information, in a case where the second display object is determined to be displayed superposed on the first display object, the display control section controls the display apparatus to display the temporary object corresponding to the second display object in a manner superposed on the first display object.

(5)

The information processing apparatus as stated in any one of paragraphs (2) to (4) above in which, when the process of rendering the second display object is completed, the display control section controls the display apparatus to display the second display object in place of the temporary object corresponding to the second display object.

(6)

The information processing apparatus as stated in any one of paragraphs (2) to (5) above, in which the temporary object includes the display object created on the basis of a contour of the display object.

(7)

The information processing apparatus as stated in paragraph (2) above, in which the temporary object includes the display object created by use of at least one of plural template objects each having a shape determined beforehand.

(8)

The information processing apparatus as stated in paragraph (7) above, in which the template objects have only one of either a circular shape or a polygonal shape each.

(9)

The information processing apparatus as stated in paragraph (7) or (8) above, further including:

a storage section configured to store the plural template objects.

(10)

The information processing apparatus as stated in any one of paragraphs (2) to (9) above in which, before the process of rendering the first display object is completed, the display control section controls the display apparatus to display the temporary objects individually corresponding to the first and the second display objects.

(11)

The information processing apparatus as stated in any one of paragraphs (2) to (10) above, in which the amount of information is related to display by the display apparatus.

(12)

The information processing apparatus as stated in any one of paragraphs (1) to (11) above, in which

the first display object includes a dynamic object moving spontaneously in the content, and

the second display object includes a static object not moving spontaneously in the content.

(13)

The information processing apparatus as stated in any one of paragraphs (1) to (11) above, in which priority levels for the processes of rendering the first and the second display objects are set according to scenes in the content.

(14)

The information processing apparatus as stated in any one of paragraphs (1) to (11) above, in which the first display object has a larger amount of character information than the second display object.

(15)

The information processing apparatus as stated in paragraph (14) above, in which

the content includes display objects related to traffic rules corresponding to the position information,

the first display object includes the character information representing characters related to the traffic rules, and

the second display object includes graphic information representing a graphic related to the traffic rules.

(16)

The information processing apparatus as stated in paragraph (15) above in which,

on the basis of the position information, the object acquisition section acquires the object information regarding a third display object not including information related to the traffic rules, and

the rendering processing section performs the process of rendering the second display object in preference over a process of rendering the third display object, on the basis of the acquired object information regarding the third display object.

(17)

The information processing apparatus as stated in any one of paragraphs (1) to (16) above, in which

the display apparatus includes an HMD, and

the display control section controls the HMD to arrange and display the first and the second display objects in a display area of the HMD, based on the position information indicating a position of the HMD in real space and on sensing results from a sensor section.

(18)

The information processing apparatus as stated in paragraph (17) above, in which

the HMD includes transmissive AR glasses,

the sensor section includes a camera for capturing the real space, and

the display control section controls the HMD to arrange and display the first and the second display objects at predetermined positions in the display area corresponding to the real space.

(19)

An information processing method including:

on the basis of position information regarding a display apparatus for displaying content, causing an information processing apparatus to acquire object information regarding display objects included in the content;

causing the information processing apparatus to perform a process of rendering a first display object in preference over a process of rendering a second display object, on the basis of the acquired object information; and

causing the information processing apparatus to control the display apparatus to display the display object of which the rendering process is completed, on the basis of the position information.

(20)

A program for causing a computer to execute a process including:

on the basis of position information regarding a display apparatus for displaying content, acquiring object information regarding display objects included in the content;

performing a process of rendering a first display object in preference over a process of rendering a second display object, on the basis of the acquired object information; and

controlling the display apparatus to display the display object of which the rendering process is completed, on the basis of the position information.

### REFERENCE SIGNS LIST

10 HMD, 11 Display section, 12 Camera, 31 CPU, 32 Memory, 33 Sensor section, 51 Control section, 52 Image acquisition section, 53 Display section, 71 Position estimation section, 72 Object acquisition section, 73 Priority level setting section, 74 Temporary object creation section, 75 Display control section, 81 Rendering processing section, 82 Superposition determination section

1. An information processing apparatus comprising:
an object acquisition section configured to, on a basis of position information regarding a display apparatus for displaying content, acquire object information regarding display objects included in the content;
a rendering processing section configured to perform a process of rendering a first display object in preference over a process of rendering a second display object, on a basis of the acquired object information; and
a display control section configured to control the display apparatus to display the display object of which the rendering process is completed, on the basis of the position information.

2. The information processing apparatus according to claim 1, wherein the display control section controls the display apparatus to display the first display object when the process of rendering the first display object is completed, as well as a temporary object having an amount of information smaller than that of the display object to be displayed, the temporary object corresponding to the second display object.

3. The information processing apparatus according to claim 2, wherein the display control section controls the display apparatus to arrange and display the temporary object corresponding to the second display object at a position where the second display object ought to be displayed.

4. The information processing apparatus according to claim 3, wherein, on the basis of the position information, in a case where the second display object is determined to be displayed superposed on the first display object, the display control section controls the display apparatus to display the temporary object corresponding to the second display object in a manner superposed on the first display object.

5. The information processing apparatus according to claim 2, wherein, when the process of rendering the second display object is completed, the display control section controls the display apparatus to display the second display object in place of the temporary object corresponding to the second display object.

6. The information processing apparatus according to claim 2, wherein the temporary object includes the display object created on a basis of a contour of the display object.

7. The information processing apparatus according to claim 2, wherein the temporary object includes the display object created by use of at least one of plural template objects each having a shape determined beforehand.

8. The information processing apparatus according to claim 7, wherein the template objects have only one of either a circular shape or a polygonal shape each.

9. The information processing apparatus according to claim 7, further comprising:
a storage section configured to store the plural template objects.

10. The information processing apparatus according to claim 2, wherein, before the process of rendering the first display object is completed, the display control section controls the display apparatus to display the temporary objects individually corresponding to the first and the second display objects.

11. The information processing apparatus according to claim 2, wherein the amount of information is related to display by the display apparatus.

12. The information processing apparatus according to claim 1, wherein
the first display object includes a dynamic object moving spontaneously in the content, and
the second display object includes a static object not moving spontaneously in the content.

13. The information processing apparatus according to claim 1, wherein priority levels for the processes of rendering the first and the second display objects are set according to scenes in the content.

14. The information processing apparatus according to claim 1, wherein the first display object has a larger amount of character information than the second display object.

15. The information processing apparatus according to claim 14, wherein
the content includes display objects related to traffic rules corresponding to the position information,
the first display object includes the character information representing characters related to the traffic rules, and
the second display object includes graphic information representing a graphic related to the traffic rules.

16. The information processing apparatus according to claim 15, wherein,
on the basis of the position information, the object acquisition section acquires the object information regarding a third display object not including information related to the traffic rules, and
the rendering processing section performs the process of rendering the second display object in preference over a process of rendering the third display object, on a basis of the acquired object information regarding the third display object.

17. The information processing apparatus according to claim 1, wherein
the display apparatus includes an HMD, and
the display control section controls the HMD to arrange and display the first and the second display objects in a display area of the HMD, based on the position information indicating a position of the HMD in real space and on sensing results from a sensor section.

18. The information processing apparatus according to claim 17, wherein
the HMD includes transmissive AR glasses,
the sensor section includes a camera for capturing the real space, and
the display control section controls the HMD to arrange and display the first and the second display objects at predetermined positions in the display area corresponding to the real space.

19. An information processing method comprising:
on a basis of position information regarding a display apparatus for displaying content, causing an information processing apparatus to acquire object information regarding display objects included in the content;
causing the information processing apparatus to perform a process of rendering a first display object in preference over a process of rendering a second display object, on a basis of the acquired object information; and
causing the information processing apparatus to control the display apparatus to display the display object of which the rendering process is completed, on the basis of the position information.

20. A program for causing a computer to execute a process comprising:
on a basis of position information regarding a display apparatus for displaying content, acquiring object information regarding display objects included in the content;
performing a process of rendering a first display object in preference over a process of rendering a second display object, on a basis of the acquired object information; and
controlling the display apparatus to display the display object of which the rendering process is completed, on the basis of the position information.
